(19) United States
(12) Patent Application Publication
(10) Pub. No.: US 2006/0246886 A1
(43) Pub. Date: Nov. 2, 2006

(54) Network support for campus and building security

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/120,012

(22) Filed: May 2, 2005

(51) Int. Cl. H04Q 7/20

(52) U.S. Cl. 455/422.1

(57) ABSTRACT

An apparatus in one example has: at least one microcell in a wireless telecommunications network, the at least one microcell defining a security zone; and a storage in the network, the storage having a secure zone occupant list of any mobile terminals presently within the security zone.

### TECHNICAL FIELD

The invention relates generally to telecommunication networks, and more particularly to a telecommunication network that provides security features for a predetermined area, such as a campus or building.

### BACKGROUND

Cellular telephone communications technologies have advanced rapidly in the last decade. A key advance in the development of cellular telephone communications is the advent of digital microcells. Such systems use of a plurality of contiguous cells, each cell with a master site and a plurality of zone sites defining communication zones, which are defined by a plurality of suitably positioned antenna sets within the periphery of the cell. Consequently, each zone has a transmitting and receiving means directionally configured to limit propagation of signals substantially to a zone within the boundaries of the cell.

Microcell network architecture typically covers “deadspots” or high traffic density areas occurring in larger macrocells. For example, one cell structure that may be suitable for high traffic personal communication networks includes a plurality of macrocells. A plurality of microcells is selectively deployed within a macrocell in areas of very high traffic density. The microcell architecture allows an increase in caller handling capacity. A typical macrocell may be 1 km or more in radius. A typical microcell may cover an area of approximately 200 m radius, for example, with each microcell typically having a capacity of handling 8 to 16 callers.

In a typical analog cellular telephone system, a plurality of contiguous cells, each having a different assigned set of transmission frequencies, are arranged with handoff means for maintaining continuous communication with mobile telephones moving from cell to cell. As a mobile unit travels along a path that passes from one cell to another, a handoff occurs which switches the mobile unit from a frequency in the set assigned to the cell it is leaving, to a new frequency in the set assigned to the cell it is entering. The handoff action is controlled by a mobile telephone switching office (MTSO), which receives a handoff command or instruction. The handoff command is typically generated when the signal received from the mobile telephone falls below a pre-selected signal strength thus indicating that the mobile telephone is at the cell boundary.

In an analog system, each cell in a cellular telephone system operates with a different assigned set of transmission frequencies. As a mobile telephone passes from one cell to another, the handoff signal instructs the cell which the mobile telephone is entering to begin transmitting at a frequency which is different from the frequency which was being transmitted by the cell which the mobile telephone was leaving. A similar procedure is followed when the mobile telephone passes into the next contiguous cell. Sets of assigned frequencies are different for adjacent cells, and such sets are not repeated except for cells that are far enough away from each other so that interference problems will not occur. In the case of systems using identification codes, the identification codes are generally not repeated.

A mobile telephone unit typically contains a control unit, a transceiver, and an antenna system. Each cell site typically is provided with a control unit, radio, a power plant, data terminals, and antennas. The MTSO provides coordination for all the cell sites and contains suitable processing and switching means. The MTSO also interfaces with the telephone company zone offices for standard hardwired telephone systems. The communication links between the MTSO and the various cell sites are typically microwave, T carriers, or optical fiber, and carry both voice and control data between the cell sites and the MTSO.

Many business campuses or individual buildings employ security personnel to verify the identity of persons entering the premises. Most often employees are also equipped with ID (identification) badges that permit entry outside of normal business hours. However, with the recent emphasis on security aspects related to terrorism, government and business institutions have desired a way to identify the occupants within a building at a given time. The traditional method of login/logout using ID badges fails in this way, because 1) people can “piggyback” on other employees without logging in or out, or 2) a person can login/logout, then change his/her mind by not actually entering/leaving the premises.

Thus there is a drawback in the prior art regarding security for buildings and other areas based only on ID badges.

### SUMMARY

The invention in one implementation encompasses an apparatus. The apparatus comprises an event-driven mobile registration function for mobile terminal transitions into or out of a secure zone in a telecommunications network.

The invention in another implementation encompasses an apparatus. This apparatus comprises at least one microcell in a wireless telecommunications network, the at least one microcell defining a security zone; and a storage in the network, the storage having a secure zone occupant list of any mobile terminals presently within the security zone.

Another implementation of the invention encompasses a method. The method comprises: defining a security zone for a telecommunications network; detecting a presence of a mobile terminal within the security zone; and storing data indicative of the mobile terminal being within the security zone.

### DESCRIPTION OF THE DRAWINGS

Features of exemplary implementations of the invention will become apparent from the description, the claims, and the accompanying drawings in which:

FIG. 1 is a representation of one implementation of an apparatus that provides security features for a predetermined area, such as a campus or building;

FIG. 2 is a representation of one exemplary flow diagram for providing security according to one implementation of the present method; and

FIG. 3 is a representation of another exemplary flow diagram for providing security according to another implementation of the present method.

### DETAILED DESCRIPTION

A methodology according to the present apparatus and method is for a network to support provisioning a zone as a “secure” zone. The network further provisions event-driven mobile registration for mobile transitions into or out of a zone identified as a secure zone. The network is also able to produce a list of secure zone occupants on demand, as well as, to provide in/out status for a particular mobile subscriber (mobile terminal).

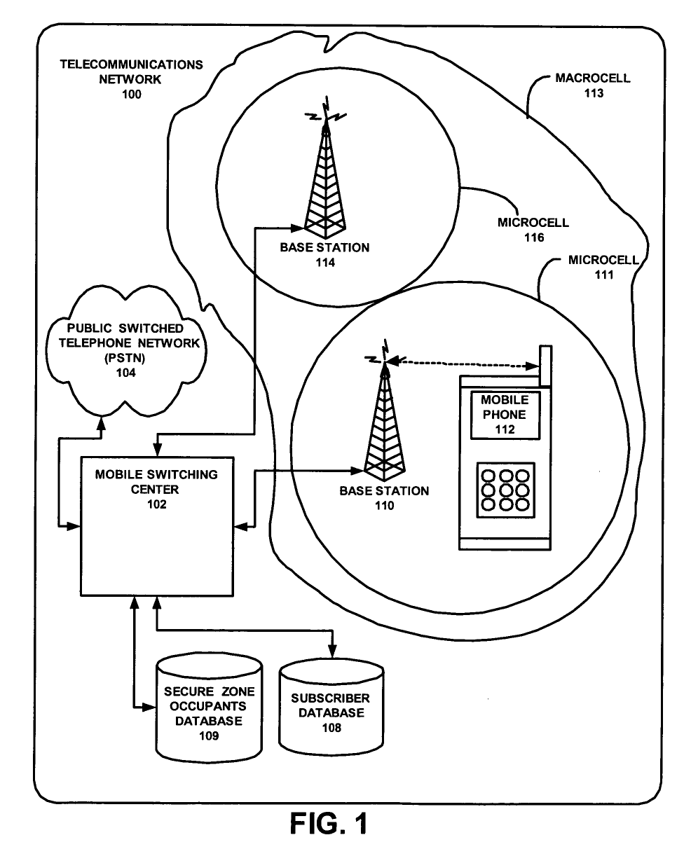

FIG. 1 is a representation of one implementation of an apparatus that provides security features for a predetermined area, such as a campus or building.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 routes calls to and from a mobile terminal 112 through the MSC 102. The MSC 102 may also be connected to at least one base station (BS) 110. The base station 110 may communicate with the mobile terminal 112 in its service area (microcell 111 which is part of a macrocell 113) using a subscriber database 108. The MSC 102 may also be operatively coupled to base stations in other microcells, such as, base station 114 in microcell 116.

The PSTN 104 generally may be implemented as the worldwide voice telephone network accessible to all those with telephones and access privileges (e.g., AT&T long distance network). The MSC may also have a secure zone occupants database 109. The mobile terminal 112 may be any one of a number of devices, such as a cell phone, a personal data assistant (PDA), a laptop computer, etc.

As depicted in FIG. 1 the macrocell 113 may contain one or more microcells, such as microcells 111 and 116. The microcell 111 may correspond to a secure zone in a first building, and the microcell 116 may correspond to a secure zone in a second building. A service provider may install the microcells 111 and 116, and define these microcells as secure zones. Microcell 111 is shown having a mobile phone 112 (mobile terminal) within its operational area. The presence of the mobile phone 112 is stored in the secure zone occupants database 109. If the mobile phone moves, for example, from the microcell 111 to the microcell 116, the absence of the mobile phone 112 from the microcell 111 and its presence now in microcell 116 is recorded in the secure zone occupants database 109. Each microcell may have a corresponding database, or a single database may be utilized wherein the different microcells are distinguishable.

The network detects when a respective mobile terminal leaves the secure zone by detecting a mobile registration message into a further zone, the network then deleting the mobile user from the secure zone occupant list corresponding to the secure zone that the mobile terminal just left. The network also detects when a respective mobile terminal enters the secure zone by detecting a mobile registration message of the respective mobile terminal for the secure zone, the network then adding the mobile user to the secure zone occupant list corresponding to the secure zone that the mobile terminal just entered.

If a respective mobile terminal is currently conducting a call as the mobile terminal enters or leaves the secure zone, the respective mobile terminal is added to or removed from, respectively, the secure zone occupant list based on existing handoff messages of the respective mobile terminal.

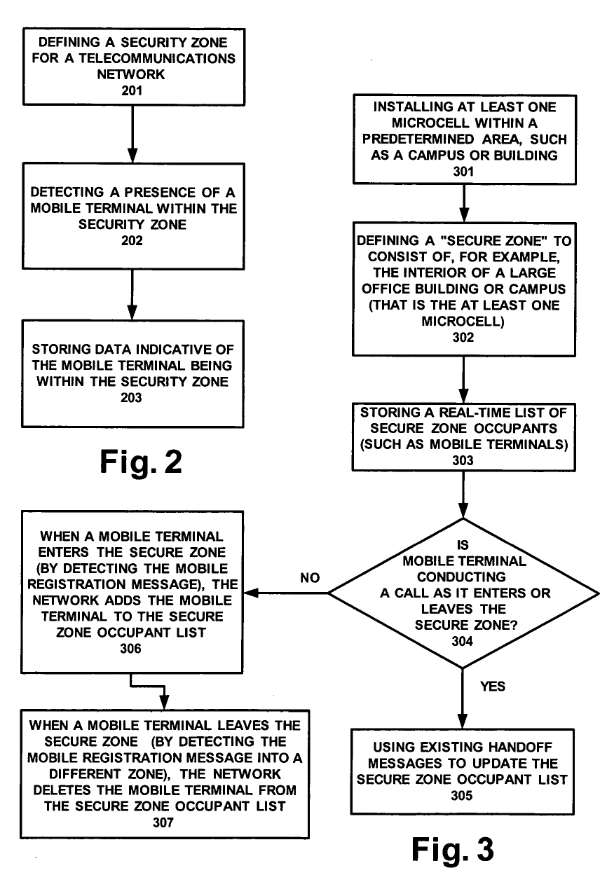

FIG. 2 is a representation of one exemplary flow diagram for implementing a telecommunications-based secure zone. The method may have the steps of: defining a security zone for a telecommunications network (201); detecting a presence of a mobile terminal within the security zone (202); and storing data indicative of the mobile terminal being within the security zone (203).

FIG. 3 is a representation of one exemplary flow diagram for implementing a telecommunications-based secure zone. This method may have the steps of:

Installing at least one microcell within a predetermined area, such as a campus or building. Currently, microcell technology exists to provide wireless coverage over a limited area, such as in an underground garage, within tunnels, buildings, etc. (301)

Defining a “secure zone” to consist of, for example, the interior of a large office building or campus (that is the at least one microcell) (302).

Storing a real-time list of secure zone occupants (such as mobile terminals) (303).

If a mobile subscriber is on a call as be/she enters or leaves the premises (304), using existing handoff messages to update the secure zone occupant list (305).

When a mobile terminal enters the “secure zone” defined above (by detecting the mobile registration message), the network adding the mobile user to the secure zone occupant list (306).

When a mobile terminal leaves the “secure zone” defined above (by detecting the mobile registration message into a different zone), the network deleting the mobile user from the secure zone occupant list (307).

Embodiments of the present apparatus and method overcomes the drawbacks of the prior art by providing employees with a “presence” indicator (i.e., a mobile phone) in addition to the traditional ID badge.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus 100 may comprise the recordable data storage medium (subscriber database 108). The computer-readable signal-bearing medium for the apparatus 100 in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
an event-driven mobile registration function for mobile terminal transitions into or out of a secure zone in a telecommunications network.

2. The apparatus defined in claim 1, wherein the telecommunications network has at least one microcell that defines the security zone, wherein the telecommunications network has a storage, and wherein the storage has a secure zone occupant list of any mobile terminals presently within the security zone.

3. The apparatus defined in claim 2, wherein a respective mobile terminal is added or removed from the secure zone occupant list based on a mobile terminal registration message of the respective mobile terminal.

4. The apparatus defined in claim 2, wherein the network produces a list of secure zone occupants on demand.

5. The apparatus defined in claim 2, wherein the network provides in/out status for a respective mobile terminal.

6. The apparatus defined in claim 2, wherein the secure zone comprises at least a plurality of microcells.

7. An apparatus, comprising:
at least one microcell in a wireless telecommunications network, the at least one microcell defining a security zone; and
a storage in the network, the storage having a secure zone occupant list of any mobile terminals presently within the security zone.

8. The apparatus defined in claim 7, wherein a respective mobile terminal is added or removed from the secure zone occupant list based on a mobile terminal registration message of the respective mobile terminal.

9. The apparatus defined in claim 7, wherein the network produces a list of secure zone occupants on demand.

10. The apparatus defined in claim 7, wherein the network provides in/out status for a respective mobile terminal.

11. The apparatus defined in claim 7, wherein a respective mobile terminal is added or removed from the secure zone occupant list by detecting a mobile registration message of the respective mobile terminal into a further zone.

12. The apparatus defined in claim 7, wherein, if a respective mobile terminal is currently conducting a call as the mobile terminal enters or leaves the secure zone, the respective mobile terminal is added to or removed from, respectively, the secure zone occupant list based on existing handoff messages of the respective mobile terminal.

13. The apparatus defined in claim 7, wherein, the network detects when a respective mobile terminal leaves the secure zone by detecting a mobile registration message into a further zone, the network then deleting the mobile user from the secure zone occupant list.

14. The apparatus defined in claim 7, wherein, the network detects when a respective mobile terminal enters the secure zone by detecting a mobile registration message of the respective mobile terminal for the secure zone, the network then adding the mobile user to the secure zone occupant list.

15. The apparatus defined in claim 7, wherein the secure zone comprises at least one of an interior of a building or a campus.

16. The apparatus defined in claim 7, wherein the secure zone comprises at least a plurality of microcells.

17. A method, comprising:
defining a security zone for a telecommunications network;
detecting a presence of a mobile terminal within the security zone; and
storing data indicative of the mobile terminal being within the security zone.

18. The method according to claim 17, wherein the security zone is defined by at least one microcell in a wireless telecommunications network, and wherein the data indicative of the mobile terminal being within the security zone is stored in a storage in the network.

19. The method defined in claim 17, wherein a respective mobile terminal is added or removed from a secure zone occupant list based on a mobile terminal registration message of the respective mobile terminal.

20. The method defined in claim 19, wherein the network produces a list of secure zone occupants on demand, and wherein the network provides in/out status for a respective mobile terminal.

21. The method defined in claim 19, wherein a respective mobile terminal is added or removed from the secure zone occupant list by detecting a mobile registration message of the respective mobile terminal into a further zone.

22. The method defined in claim 19, wherein, if a respective mobile terminal is currently conducting a call as the mobile terminal enters or leaves the secure zone, the respective mobile terminal is added to or removed from, respectively, the secure zone occupant list based on existing handoff messages of the respective mobile terminal.
